(19) United States
(12) Patent Application Publication
(10) Pub. No.: US 2015/0033192 A1
(43) Pub. Date: Jan. 29, 2015

(54) METHOD FOR CREATING EFFECTIVE INTERACTIVE ADVERTISING CONTENT

(71) Applicant: 3M INNOVATIVE PROPERTIES COMPANY, St. Paul, MN (US)

(72) Inventors: KANDYCE M. BOHANNON, CEDAR PARK, TX (US); GERALD L. KAREL, MAPLEWOOD, MN (US)

(73) Assignee: 3M INNOVATIVE PROPERTIES COMPANY, St. Paul, MN (US)

(21) Appl. No.: 13/948,359

(22) Filed: Jul. 23, 2013

(51) Int. Cl. G06F 3/01

(52) U.S. Cl. CPC G06F 3/017
USPC 715/863

(57) ABSTRACT

A method for interacting with a viewer of a digital signage display providing advertising content. When a person is detected in view of the display, a user representation of the person, such as a silhouette or avatar, is generated and shown on the display. While the person remains in view of the display, the method shows a manipulation of the user representation such as a displayed alteration of it or the user representation interacting with or experiencing a displayed product. With use of the displayed user representation, the person effectively becomes part of the displayed advertisement while in view of the display.

### BACKGROUND

At a high level, digital signage is an electronic display that shows some form of advertisement, brand promotion, or other information that may be useful to people passing by the signage. In the world of advertising and marketing there are certain trends that may shape the future of digital signage. One of these trends is known as experience branding, which allows the user to experience the product or brand because people tend to remember experiences, not brand messages or advertisements. Another trend is pervasive advertising, a term used to describe an advertisement experience with bidirectional communication in that the user chooses the advertisements, which provides brand owners insight into what consumers want to see. To incorporate these two trends, the signage must be interactive.

The following are three issues in interactive digital signage. First, people must notice the display. To a large extent it is the appearance of the display (such as brightness and the content shown) and where it is located that draws people's attention to it. However, for people to notice the display there is more to overcome than simply increasing the brightness of it. As a result of living in this economy of attention, a common phenomenon that occurs is display blindness, similar to banner blindness in web browsing, which results in people ignoring the signage.

The next issue is that people must notice the display is, in fact, interactive. There are four ways to communicate interactivity: a call to action (e.g., touching the screen to begin an advertisement); an attract sequence (e.g., an illustrative description of what to do); analog signage (additional signage explaining how to interact with a display); and prior knowledge (including seeing others interacting with a display before interacting with it).

Finally, people should want to interact with the signage. This issue is not as readily addressed as the other two issues because it is related to the reward and enjoyment of the interaction. Tangible rewards such as coupons could be given to users who interact with the signage system in order to encourage interaction. However, this reward can lead to people circumventing the system and oftentimes costs more for the brand.

Accordingly, a need exists for digital signage to address the issues described above, for example, in providing for an interactive advertising experience with a person.

### SUMMARY

A method for interacting with a viewer of a display providing advertising content, consistent with the present invention, includes displaying content on a display and detecting a person in view of a display. The method also includes generating a user representation of the person and showing a manipulation of the user representation on the display while the person is in view of the display.

A system for interacting with a viewer of a display providing advertising content, consistent with the present invention, includes a sensor, a display, and a processor coupled to the sensor and display. The processor is configured to display content on the display and detect a person in view of a display. The processor is also configured to generate a user representation of the person and show a manipulation of the user representation on the display while the person is in view of the display.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram of a system for generating interactive advertising content;

FIG. 2 is a flow chart of method for generating interactive advertising content;

FIG. 3 is a diagram of a user interface illustrating display of advertising items;

FIG. 4 is a diagram of a user interface on a display illustrating display of a user representation of a person in view of the display;

FIG. 5 is a diagram of a user interface illustrating display of a manipulation of the user representation;

FIG. 6 is a diagram of a user interface illustrating display of the user representation holding a product; and

FIG. 7 is a diagram of a user interface illustrating display of the user representation pointing to a portion of the user interface having product-related information.

### DETAILED DESCRIPTION

Embodiments of the present invention include features for interactive content for the purpose of advertisement and other brand promotional activities. An important one of these features is to use the passers-by of digital signage as part of the advertisement as a play on experience branding. Furthermore, it is possible to show targeted advertisements depending on the person walking by. By focusing on the surprise and fun of a person's interaction, the advertisement can be more effective, since passers-by may be surprised to see themselves in the content of the signage. In order to further attract and maintain a person's attention, the representation of the passer-by can extend beyond simply mimicking its owner by being manipulated in various ways.

For example, consider a display showing content to promote a beverage brand. After the user representation of the person at the display has been shown on the display and the user has indicated they are interested (perhaps by interacting for some amount of time), the user's representation on the display will no longer follow its owner but instead is shown holding or consuming the beverage. Further interactive aspects can include keeping the user's representation interacting in the display for a relatively short amount of time or incorporating miniature games and quests for the user to accomplish via interacting with the display.

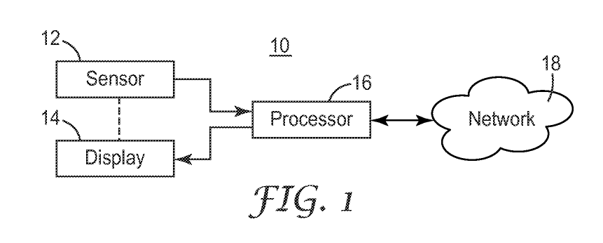

FIG. 1 is a diagram of a system 10 for generating interactive advertising content. System 10 includes a sensor 12, a display 14, and a processor 16 electronically coupled to sensor 12 and display 14. Processor 16 can also include a connection with a network 16 such as the Internet. In use, processor 16 detects via sensor 12 a person within the vicinity or view of display 14, and processor 16 provides for interaction with the person via display 14 while the person is in view of it.

Display 14 can be implemented with an electronic display for displaying information. Examples of display 14 include a liquid crystal display (LCD), a plasma display, an electrochromic display, a light emitting diode (LED) display, and an organic light emitting diode (OLED) display. Processor 16 can be implemented with any processor or computer-based device. Sensor 12 can be implemented with an active depth sensor, examples of which include the KINECT sensor from Microsoft Corporation and the sensor described in U.S. Patent Application Publication No. 2010/0199228, which is incorporated herein by reference as if fully set forth. Sensor 12 can also be implemented with other types of sensors associated with display 14 such as a digital camera or image sensor. Sensor 12 can be located proximate display 14 for detecting the presence of a person within the vicinity or view of display 14.

Sensor 12 can optionally be implemented with multiple sensors, for example a sensor located proximate display 14 and another sensor not located proximate display 14. As another option, one of the multiple sensors can include a microphone for detection of the voice (e.g., language) of a person in view of the display. The system can optionally include an output speaker to further enhance the interaction of the system with the person in view of the display.

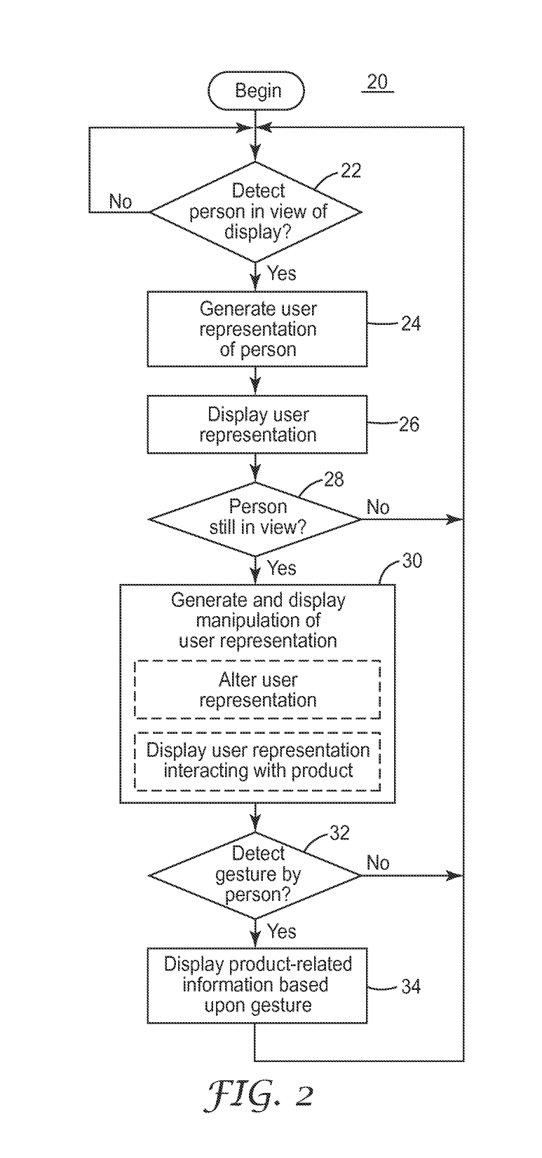

FIG. 2 is a flow chart of a method 20 for generating interactive advertising content. Method 20 can be implemented in software, for example, for execution by processor 16. The software can be stored in a storage device, such as a memory, for retrieval and execution by processor 16.

In method 20, processor 16 determines via sensor 12 if a person is in view of display 14 (step 22). If a person is in view of display 14, processor 16 generates a user representation of the person based upon information received from sensor 12 (step 24) and displays the user representation on display 14 (step 26). A user representation can be, for example, an image, silhouette, or avatar of the person. An image as the user representation can be obtained from sensor 12 when implemented with a digital camera. A silhouette as the user representation includes a shadow or outline representing the person and having the same general shape as the person's body. The silhouette can be generated by processing the information from sensor 12, such as a digital image or outline of the person, and converting it to a representative silhouette. An avatar as the user representation is a cartoon-like representation of the person. The avatar can be generated by processing information from sensor 12, such as a digital image of the person, and converting it into a cartoon-like figure having similar features as the person.

Table 1 provides sample code for processing information from sensor 12 to generate a user representation of a person in view of display 14. This sample code can be implemented in software for execution by a processor such as processor 16.

TABLE 1
Pseudo Code for User Representation Algorithm

```
while(personInView) {
  backgroundSubtraction( )
  if(personPlayingTime > threshold)
    modifyPersonImage( )
  drawScene( )
  drawPerson( )
}
```

If the person remains in view of display 14 for a particular time period (step 28), processor 16 generates and displays on display 14 a manipulation of the user representation. The particular time period can be used to distinguish between a person at the display rather than a person walking by the display without stopping. Alternatively, the time period can be selected to include a time short enough to encompass a person walking by the display. Displaying a manipulation of the user representation in intended, for example, to help obtain or maintain the person's interest in viewing the display. Examples of a manipulation include displaying an alteration of the user representation or displaying the user representation interacting with a product, as illustrated below. Other manipulations are also possible.

Table 2 provides sample code for generating manipulations of the user's representation for the examples of a “floating head” and holding a beverage, as further illustrated in the user interfaces described below. This sample code can be implemented in software for execution by a processor such as processor 16.

TABLE 2
Pseudo Code for Manipulation of User Representation

```
modifyPersonImage( ) {
    if(modification == drinkBeverage)
      newUserRightHandPosition = userRightHandPosition +
ratio*personPlayingTime
      beveragePosition = newUserRightHandPosition
      drawBeverage(beveragePosition)
    else if(modification == floatingHead)
      newHeadPosition = userHeadPosition + ratio*personPlayingTime
  }
```

Processor 16 via sensor 12 also determines if it detects a particular gesture by the person as determined by information received from sensor 12 (step 32). Such a gesture can include, for example, the person selecting or pointing to a product or area on display 14. If the gesture is detected, processor 16 displays on display 14 product-related information based upon the gesture (step 34). For example, processor 16 can display information about a product the person pointed to or selected on display 14. Product-related information can be retrieved by processor 16 from network 18, such as via accessing a web site for the product, or from other sources.

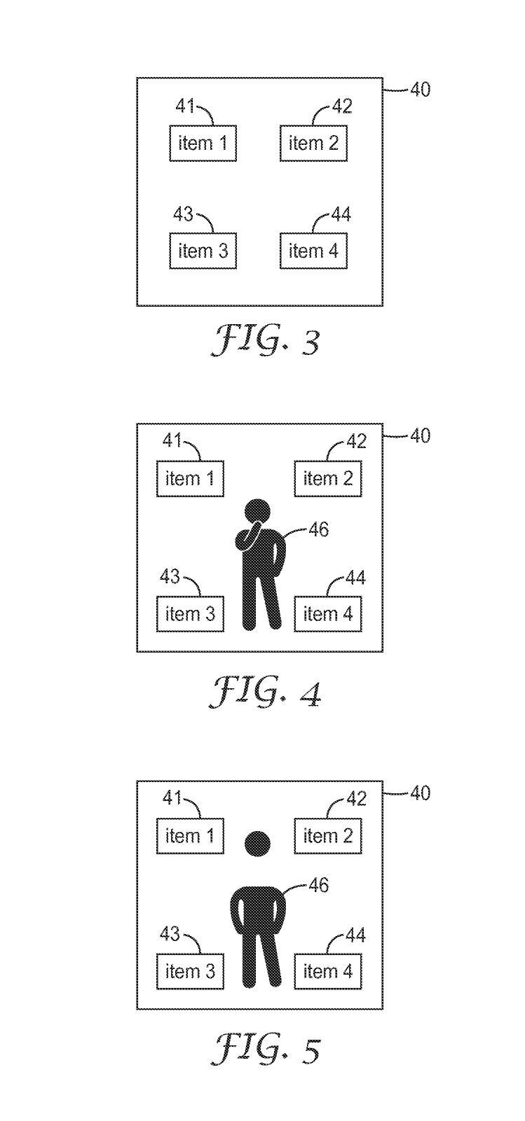

FIGS. 3-7 are diagrams of various configurations of an exemplary user interface 40 illustrating interactive advertising with a person in view of display 14. These user interfaces can be generated in software, for example, for display on display 14 under control of processor 16.

FIG. 3 is a diagram of user interface 40 on display 14 illustrating display of advertising items in portions 41, 42, 43, and 44 of interface 40. These displayed items can represent product-related information, for example icons, pictures, diagrams, graphics, textual descriptions, video, or audio relating to products. These items can also include descriptions of services. Advertising content includes, for example, these types of items or any other information describing, relating to, or promoting products or services. Four items are shown for illustrative purposes only; user interface 40 can display more or fewer items and in various configurations on the user interface.

FIG. 4 is a diagram of user interface 40 on display 14 illustrating display of a user representation 46 of a person in view of display 14. This diagram illustrates an example of processor 16 generating and displaying a user representation for steps 24 and 26 in method 20. In this exemplary configuration, processor 16 has moved portions 41-44 in order to display user representation 46 in the center of the user interface 40. This user representation 46 illustrates a silhouette or shadow representing the person and can be shown having the same general posture of the person in view of the display in order to attract the person's attention, for example. A user representation can provided in other areas of the display or even overlaid over other displayed items.

FIG. 5 is a diagram of user interface 40 on display 14 illustrating display of a manipulation of user representation 46. This diagram illustrates an example of processor 16 generating and displaying a manipulation of user representation for step 30 in method 20. In this example, processor 16 has manipulated user representation 46 to show the representation with a “floating head,” which could help to catch the person's attention by showing their own representation altered in a particular way. Other manipulations of a user representation are possible for display in interface 40.

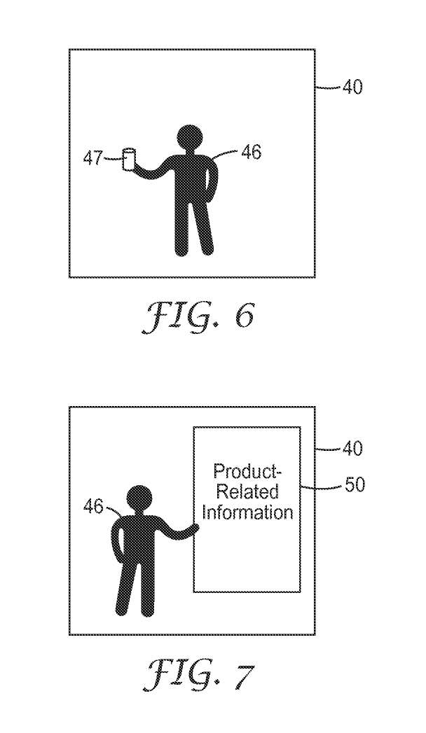

FIG. 6 is a diagram of user interface 40 on display 14 illustrating display of user representation 46 holding a product 47. This diagram illustrates another example of processor 16 generating and displaying a manipulation of user representation for step 30 in method 20. In this example, processor 16 has manipulated user representation 46 to show the representation holding product 47, such as a beverage featured or described in one of the portions 41-44. Showing the person via the user representation interacting with a product can also help to catch the person's attention by showing the person experiencing a product, for example. Other manipulations of a user representation are possible to show the user representation in interface 40 interacting with or experiencing a product.

FIG. 7 is a diagram of user interface 40 on display 14 illustrating display of user representation 46 pointing to a portion of the user interface having product-related information 50. This diagram illustrates an example of processor 16 displaying product-related information for step 34 in method 20. For example, if the person pointed to or selected a product featured in one of portions 41-44 in user interface 40, processor 16 can then display information about the product in portion 50 and show the user representation pointing to or gesturing at the displayed product-related information.

Other manipulations of a user representation are possible. For example, a user representation can be shown with various types of clothing in order to promote particular brands of clothing. In a fitness or wellness type of brand promotion, a user representation can be altered to show how the user would look after a period of time on an exercise or nutritional program.

1. A method for interacting with a viewer of a display providing advertising content, comprising:
displaying content on an electronic display;
detecting a person in view of the display;
generating a user representation of the person; and
showing a manipulation of the user representation on the display,
wherein the detecting, generating, and showing steps occur while the person is in view of the display.

2. The method of claim 1, wherein the detecting step comprises using a camera to detect the person.

3. The method of claim 1, wherein the detecting step comprises using a depth sensor to detect the person.

4. The method of claim 1, wherein the generating step comprises generating an image of the person.

5. The method of claim 1, wherein the generating step comprises generating a silhouette of the person.

6. The method of claim 1, wherein the generating step comprises generating an avatar of the person.

7. The method of claim 1, wherein the showing step comprises showing an alteration of the user representation.

8. The method of claim 1, wherein the showing step comprises showing the user representation interacting with a displayed product.

9. The method of claim 1, wherein the showing step comprises showing the user representation holding a displayed product.

10. The method of claim 1, further comprising:
detecting a gesture by the person; and
displaying product-related information on the display based upon the gesture.

11. A system for interacting with a viewer of a display providing advertising content, comprising:
a sensor
an electronic display; and
a processor coupled to the sensor and the display, wherein the processor is configured to:
display content on the display;
detect a person in view of the display;
generate a user representation of the person; and
show a manipulation of the user representation on the display,
wherein the detecting, generating, and showing occur while the person is in view of the display.

12. The system of claim 11, wherein the sensor comprises a camera.

13. The system of claim 11, wherein the sensor comprises a depth sensor.

14. The system of claim 11, wherein the processor is configured to generate an image of the person as the user representation.

15. The system of claim 11, wherein the processor is configured to generate a silhouette of the person as the user representation.

16. The system of claim 11, wherein the processor is configured to generate an avatar of the person as the user representation.

17. The system of claim 11, wherein the processor is configured to show an alteration of the user representation.

18. The system of claim 11, wherein the processor is configured to show the user representation interacting with a displayed product.

19. The system of claim 11, wherein the processor is configured to show the user representation holding a displayed product.

20. The system of claim 11, wherein the processor is further configured to:
detect a gesture by the person; and
display product-related information on the display based upon the gesture.
